(19) United States
(12) Patent Application Publication
(10) Pub. No.: US 2016/0264216 A1
(43) Pub. Date: Sep. 15, 2016

(54) ADLS "Aircraft Dye Locating System"

(71) Applicant: Joe Radvansky, Batesville, IN (US)

(72) Inventor: Joe Radvansky, Batesville, IN (US)

(21) Appl. No.: 14/645,428

(22) Filed: Mar. 12, 2015

(51) Int. Cl. B63B 22/26; B64D 45/00

(52) U.S. Cl. CPC B63B 22/26; B64D 45/00

(57) ABSTRACT

Disclosed herein is a carrier vessel locating system, comprising at least one buoyant container storing a plurality of dye packs, at least one buoyant strobe light attached to said container and an extendable lanyard attaching said strobe light to said carrier vessel. In a preferred embodiment, the invention aims to provide temporary visual markings on a marine body that may be, readily detected by observers for locating and retrieving a carrier vessel like aircrafts those travel over a marine body and are in distress. The marking on a body of water which comprises introducing into the body of water, a water soluble dye that marks a large area with various colors of brilliance and strobe tight that is buoyant. Further the water soluble dye is stored in a container and is devised to open automatically, in the event of exposer to a marine body, to release the dye.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

(1) Field of the Invention

This invention generally relates to means used for signaling distress from aircraft that travel over bodies of water. More particularly, this inventor pertains to equipment used for marking a marine body and signaling distress that can be readily detected by rescuers for locating and retrieving a carrier vessel that is in distress.

(2) Background of Invention

People generally use aircraft for travel and to transport cargo. An aircraft flies over various types of terrain when traveling from its source to its destination. The terrain may include flat land, mountains, bodies of water, and other types of terrain. An unintended encounter may result in wreckage of different structures from the aircraft. These structures may include, a wing, an engine, a section of the fuselage, a data recorder, and/or other components.

Markers and retrieving devices that release upon immersion in water have previously been proposed to recover marine wreckage. A common type of marking device includes a solid material that dissolves upon immersion and releases a dye marker. Other emergency conditions of interest include capsized vessels, vessels that have lost power, and aircraft accidents that are in range of the Coast Guard and other rescue vessels. Operations designed to rescue personnel in these situations are complicated by the motion of an individual in the water due to ocean currents, wave motion, wind, and by the relative motion of the vessel or aircraft from which the individual originated. Storms and fog can make the problem of finding individuals lost in large bodies of water even more difficult. A time-consuming search with a large number of vessels and aircraft that cover a large area is often required. Also, there are a great many disasters that occur at sea, such as the loss of many lives when a vessel sinks.

Many times, the vessel sinks quite unexpectedly; and the captain of the vessel is unable to send any signals to indicate his exact position at the time of the sinking. Therefore, it is desirable to produce a temporary marking at or near the surface of a large or small bodies of water that may easily be seen by aerial observers. Not only search and rescue teams, but commercial aircraft flying their scheduled routes from high above can call in and report seeing a dye marker. For example, one may wish to visually locate the position of objects or devices that have been dropped into the ocean or large bodies of fresh water. In the case of ship or plane wrecks, survivors afloat on life rafts, buoys, and the like may wish to call the attention of airplanes searching for them. A submarine in distress far below the surface of the water may wish to indicate its location. In time of war, planes and ships may wish to mark the position where an enemy submarine was seen for the benefit of approaching armed craft. It is sometimes desirable to temporarily designate a landing area for the use of sea planes so that they may have an indication of the best position to land, and to facilitate estimating elevation.

### BRIEF SUMMARY OF THE INVENTION

The primary objective of the invention is to provide a carrier vessel with a dye locating system.

In a preferred embodiment, the invention aims to provide temporary visual markings on a marine body that may be readily detected by observers for locating and retrieving a carrier vessel, such as aircrafts that travel over a marine body and are in distress.

In one embodiment, the invention provides a marking on a body of water by introducing a water-soluble dye that marks a large area with bright green florescent dye, and as strobe light that is buoyant.

In another embodiment, the present invention has water-soluble dye stored in a container, and is devised to open automatically in the event of exposure to a marine body, releasing the dye.

In the same embodiment, the present invention has a buoyant strobe light that is water activated.

Furthermore, according to the same embodiment of the invention, the water-activated strobe light is attached to one of the dye-pack containers. It would contain an electronic eye to only allow its operation from dusk to dawn allowing for spotting the location at night. A solar powered battery could be installed to allow the strobe light to recharge during daylight hours.

In yet another embodiment of the present invention, the container that stores the dye is located in a specific area of the carrier vessel that will not come in contact with water when the aircraft is exposed to rain or when the vessel is washed.

Additionally, in another embodiment of the present invention, at least one dye-pack container will be placed in the rear of the carrier vessel. Generally the safest place in any aircraft accident is the tail section.

Moreover, in another embodiment of the invention, the number or dye-packs that are attached or used in a carrier vessel depends on the size of the carrier vessel. Alternately, the size of the dye pack can be tailored to the size needed for the aircraft applied to. If as dye pack is required to last for days, the size of the dye pack would be manufactured to its needs. Thus only possibility needing one per aircraft.

Furthermore, in another embodiment of the present invention, the invention can be used to signal distress in any environment. More precisely, the water-soluble dye would be visible for signaling distress during the day, and the water-activated strobe light would be visible for signaling distress at night.

Furthermore, in another embodiment of the present invention, the water-soluble dye may be chemiluminescent, which means the dye would be capable of glowing at night. Also, in one embodiment of the invention, the carrier vessel locating system is comprised of an extended lanyard with a floating device attached therefore not losing general location of the sinking wreckage. This summary is provided to introduce a selection of concepts in a simplified form that are further described below in the detailed description. The summary is not intended to identify key features or essential features of the claimed subject matter, nor is it intended to be used as an aid in determining the scope of the claimed subject matter.

In this respect, before explaining at least one embodiment of the invention in detail, it is to be understood that the invention is not limited in its application to the details of construction and to the arrangements of the components set forth in the following description, or illustrated in the drawings. The invention is capable of other embodiments, and of being practiced and carried out in various ways. Also, it is to be understood that the phraseology and terminology employed herein are for the purpose of description, and should not be regarded as limiting.

These, together with other objects of the invention and the various features of novelty which characterize the invention, are pointed out with particularity in the disclosure. For a better understanding of the invention, its operating advantages, and the specific objectives attained by its uses, reference should be made to the accompanying drawings and descriptive matter, in which there are illustrated preferred embodiments of the invention.

### BRIEF DESCRIPTION OF FIGURES OF THE DRAWINGS

The drawings constitute a part of this specification, and include exemplary embodiments to the invention, which may be embodied in various forms. It is to be understood that, in some instances, various aspects of the invention may be shown exaggerated or enlarged to facilitate an understanding of the invention.

FIG. 1 illustrates positions of the dye container on an aircraft

### DETAILED DESCRIPTION OF THE INVENTION

The following is a detailed description of example embodiments of the invention depicted in the accompanying drawing. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention, as defined by the appended claims. The detailed descriptions below are designed to make such embodiments obvious to a person of ordinary skill in the art. The invention provides a means to provide temporary visual markings on a marine body that may readily be detected by observers or satellite pictures for locating and retrieving a carrier vessel. These vessels may include different kinds of aircrafts that travel over marine bodies.

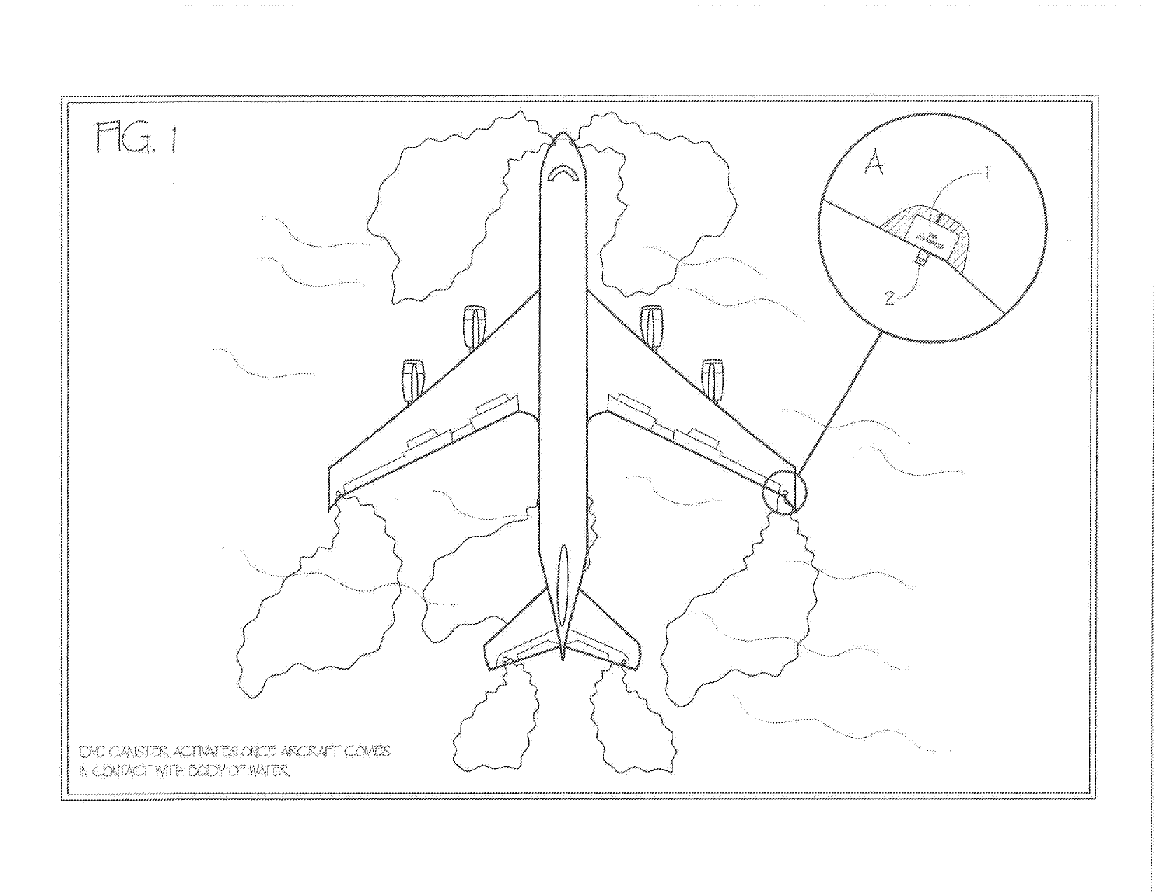

Referring to FIG. 1, there is shown an outline of an aircraft (for example, aircraft ranging from small single engine, to piston twins and corporate jets, to commercial jet airliners) and the position of the container A wherein the container can 1 be a canister that would hold the dye packs. The position of the canisters is such that they would refrain from contacting rainwater or water that is used for cleaning the aircraft.

In a preferred embodiment of the present invention, the container would open automatically when the aircraft makes contact on a body of water. The dye-packs would then activate automatically and would mark a large area of the marine body with brilliant florescent green color so that it can be noticed and be observed so that the drowned aircraft can be recovered in a quicker time frame to aid services to the survivors. Also, the dye-packs may be glowing, so that they can be used to identify the location, even at night.

Furthermore, in another preferred embodiment of the invention, the chemical dye is visible and is fluorescent green. Size area coverage depends on the amount of chemical dye being used. As an example, the amount of a chemical dye needed to cover the area of a football field would probably fit in the palm of your hand.

Referring to FIG. 1 there is shown the position of the water-activated strobe light 2 on the outline of the aircraft. The water activated strobe light would be optional on smaller general aviation aircrafts.

Moreover, according to the invention, a self-buoyant strobe light is also attached. The light is water-activated, meaning the light will be activated only in the event that it comes into contact of water. An electronic eye will only allow the strobe to activate from dusk to dawn aiding in location at night. A solar charging system will allow the battery is to recover during daylight hours.

Also, in one embodiment of the invention, the water activated strobe light is attached to the dye-pack canister, which also has a floatation device and a long lanyard attached to it act as a visual locator to help the rescue crews locate the aircraft, in case the aircraft sinks before they arrive. Government offices and facilities could also use the current invention, along with satellite pictures, current tide tables, water current charts and wind charts of the weather services to determine a very close location of a submerged aircraft.

More specifically, according to the invention, the dye-packs ire more helpful in sending distress signals in the environment where a rescue party doesn't need an area visually illuminated, such as during the day, and the water activated strobe light is more helpful in sending distress signals in the environment where a rescue party needs an area visually illuminated, such as at night. Also according to the invention, the number of dye-packs used will be according to the size of the carrier vessel, for example, a commercial airliner traveling over water will have six dye packs two packs at the extreme front near the two wing tips, and two more at the tips of the horizontal stabilizer of the aircraft. Or one large dye packet located where the manufacture and FAA deem it would be most effective. The size of the one dye pack would be determined by the manufacturer of the dye as to how much is needed to last a certain number of hours/days. Furthermore, according to the invention, if the aircraft is small, such as general aviation aircraft or corporate aircraft, only one dye pack would be necessary, and the location would be determined by the manufacturer of the aircraft and/or the FAA. The water activated strobe light could be optional for aircraft of this category.

Although specific embodiments have been illustrated and described herein, it will be appreciated by those of ordinary skill in the art that any arrangement that is calculated to achieve the same purpose may be substituted for the specific embodiment shown. This application is intended to cover any adaptations or variations of the present invention. Therefore, it is manifestly intended that this invention be limited only by the claims and the equivalents thereof.

Although the invention has been explained in relation to its preferred embodiment, it is to be understood that many other possible modifications and variations can be made without departing from the spirit and scope of the invention.

1. A carrier vessel locating system, comprising of:
at least one buoyant container storing a plurality of dye packs containing dye;
at least one buoyant strobe light attached to said container; and
an extendable lanyard attaching said strobe light to said carrier vessel.

2. The carrier vessel locating system as set forth in claim 1, wherein said buoyant container releases said stored dye packs in the event of exposer to a marine body.

3. The carrier vessel locating system as set forth in claim 1, wherein said dye in said dye packs is water soluble.

4. The carrier vessel locating system as set forth in claim 1, wherein said dye in said dye packs are color brilliant and is visible in a dark environment.

5. The carrier vessel locating system as set forth in claim 1, wherein said buoyant container are positioned in said carrier vessel to refrain from water contact during the event of rain and cleaning of the vessel.

6. The carrier vessel locating system as set forth in claim 1, wherein at least on buoyant container is located in the rear of the vessel.

7. The carrier vessel locating system as set forth in claim 1, wherein number of said buoyant container storing said dye packs depends on the size of the carrier vessel.

8. The carrier vessel locating system as set forth in claim 1, wherein said extendable lanyard attaching said strobe light to said carrier vessel extends said strobe light to the surface of said marine body to provide a visual locator to locate said carrier vessel.

9. The carrier vessel locating system as set forth in claim 1, wherein said strobe light is a flashing lamp.

10. The carrier vessel locating system as set forth in claim 1, wherein said dye in said dye packs is chemiluminescent.

11. A method for indicating the position of a carrier vessel, comprising:
providing in a water light container a plurality of dye pack to be released in an event of exposer of said container to a marine body;
providing a buoyant strobe light attached to said container to be released simultaneously with said dye to float on said marine body indicating the position is of said carrier vessel; and
attaching an extendable lanyard to said buoyant strobe light proving a visual locator to locate said carrier vessel.

12. The method for indicating the position of a carrier vessel as set forth in claim 11, further provides a means for distress signaling.
